(19) United States
(12) Patent Application Publication
(10) Pub. No.: US 2010/0001867 A1
(43) Pub. Date: Jan. 7, 2010

(54) DEVICE, SYSTEM AND METHOD FOR MONITORING TANK CONTENT LEVELS

(76) Inventors: Matthew Rodrigue, Brighton, MA (US); William Sulinski, Westbrook, ME (US); James V. Masi, Cape Elizabeth, ME (US); Isaac Horn, Boston, MA (US)

Correspondence Address: KEVIN FARRELL;PIERCE ATWOOD, ONE NEW HAMPSHIRE AVENUE, PORTSMOUTH, NH, 03801, US

(21) Appl. No.: 12/343,836

(22) Filed: Dec. 24, 2008

Related U.S. Application Data
(60) Provisional application No. 61/009,372, filed on Dec. 28, 2007.

(51) Int. Cl. G08B 21/00

(52) U.S. Cl. 340/618

(57) ABSTRACT

The present invention is directed to a system for determining content level in a fluid holding tank and requesting refills. One embodiment of the system comprises a magnet that produces a magnetic flux around a housing for an existing content level gauge, a Hall Effect sensor transmitter unit disposed on the housing and having at least one current detecting loop therein for detecting any variation in a magnetic field created by the magnet, and a metal content level gauge disposed within the housing. The degree of variation corresponds to a measured content level as indicated by a position of the metal content level gauge. The system further comprises a base station receiver transmitter unit for receiving a signal from the Hall Effect sensor transmitter unit and forwarding that signal to a remote registry.

### REFERENCE TO RELATED APPLICATION

This application claims priority to U.S. Provisional Application 61/009,372 filed on Dec. 28, 2007 and incorporated herein by reference.

### BACKGROUND

1. Field of the Invention

The present invention relates generally to the field of measurement devices and more particularly to a device, system and method for measuring and monitoring levels of a consumable fluid retained in a refillable storage tank.

2. Background of the Invention

Measurement devices for gauging content levels of fluid holding tanks, such as residential oil tanks and propane tanks, are well known in the art. Systems for monitoring fluid levels and determining refill quantities and frequencies also are known in the art. These existing devices and systems, however present several disadvantages.

One prevalent method of determining tank refill dates and quantities is the heating degree day method. Heating degree day calculations derive from daily temperature observations for a particular locality or region. By comparing daily temperatures to set point at which a building presumably requires heating or at which a building requires cooling, a company providing consumables can predict a quantity of fuel consumed for given period of time and how much refilling a tank requires. Drawbacks to this method are numerous. First, an owner may establish a set point temperature for heating and a set point temperature for cooling that depart from the assumed set points. This may lead to vastly increased or decreased consumption, departing greatly from predicted values. Second, buildings may implement insulation that successfully reduces a need for heating and/or cooling at presumed set points such that calculations based on daily outdoor temperature depart greatly from actual fuel usage. Third, solar gain and wind, not measured by external ambient temperature sensors, may contribute to actual heating and cooling requirements within a building. A building's heating requirements therefore may vary independently of local temperature fluctuations, making predictions based on linear extrapolation tenuous at best.

Miscalculations and errors inherent in the degree day system can lead to some dire situations. For example, supplying insufficient quantities of fuel during a heating season may lead to frozen pipes and costly damage. Furthermore, the largest expense incurred by fuel retailers is the cost of delivery, including fees related to drivers' salaries and truck depreciation. Inaccurate calculations in degree days may lead to more frequent deliveries, thereby costing a supply company more money.

Because heating degree day and cooling degree day calculations are inaccurate and unreliable, especially in regions having unpredictable weather patterns, fuel supply companies rely on other systems and devices for monitoring and refilling consumer tanks. For example, many holding tanks employ optical and electromechanical fluid level measurement systems. These systems include floats, capacitance probes, reed switches, ultrasonic level sensors and differential pressure mechanisms. Because these systems incur exposure to internal, caustic tank conditions, they may corrode and provide inaccurate measurements. Additionally, most of these systems also require substantial retrofitting for proper operation with an existing holding tank, which leads to additional cost for the end consumer.

Some fuel supply companies provide electronic systems for monitoring fluid level measurement systems and reporting back to the supply company when a refill is necessary. These systems generally exhibit several limitations. First, these electronic monitoring systems generally require access to a power outlet which may be unavailable or place inconveniently in cellar or basement where holding tanks usually lie. Second, these systems generally require access to a telephone line for sending a signal to a supply company, and transmitting data therefore creates a temporary disruption to a homeowner's phone line. Third, these systems and devices generally provide only a gross indication of a fuel requirement. Precise measurements are neither calculated nor transmitted. Again, these imprecise measurements can add cost to delivery and/or lead to disastrous consequences.

A need therefore exists for an improved, easily installed and implemented device, system and method for reliably and cost effectively monitoring liquid levels in refillable fuel tanks and notifying suppliers of precise refill requirements.

### SUMMARY OF THE INVENTION

The present invention is directed to a device, system and method for determining content level in a fluid holding tank. One embodiment of the system comprises an enclosure containing at least a battery source that produces an electron flow around an existing content level gauge and a circuit board with a Hall Effect sensor thereon for detecting any distortion in the electron flow's associated magnetic field. The system further comprises a metal member disposed on the existing content level gauge such that any fluctuation in content level in the fluid holding tank lowers or raises the content level gauge and metal member accordingly, thereby creating a distortion in the magnetic field created by the electron flow. The degree of any distortion depends on the position of the metal member within the electron flow. The Hall Effect sensor has at least one and preferably more than one current detecting loop disposed around a housing for the content level gauge. The Hall Effect sensor thus precisely detects distortion in the magnetic field of the electron flow and thereby determines a precise position of the metal member and precise level of the gauge.

The present invention further comprises a microprocessor in communication with the circuit board for translating data measured by the Hall Effect sensor into a content level signal. A radio frequency transmitter in communication with the microprocessor wirelessly communicates the content level signal to a remote base station having a unique identifying address. The remote base station transmits the calculated fluid level data to a remote registry via wired or wireless means, such that the registry may push data to an appropriate entity supplying fluid refills.

Another embodiment of the present invention comprises a system for determining content level in a fluid holding tank and requesting refills. One embodiment of the system comprises a magnet disposed around the base of a housing for an existing content level gauge, wherein the magnet produces a magnetic flux around the housing. The embodiment further comprises a Hall Effect sensor transmitter unit disposed on the housing and having at least one current detecting loop therein for detecting any variation in a magnetic field created by the magnet, and a metal content level gauge disposed within the housing, wherein the degree of variation corresponds to a measured content level as indicated by a position of the metal content level gauge. The embodiment also comprises a base station receiver transmitter unit for receiving a signal from the Hall Effect sensor transmitter unit and forwarding that signal to a remote registry.

Another embodiment of the present invention comprises a system for determining content level in a fluid holding tank. The system comprises a linear Hall Effect sensor transmitter unit disposed on a housing for an existing content level gauge for detecting any variation in a magnetic field created by a magnet disposed on the content level gauge disposed within the housing, wherein the degree of variation corresponds to a measured content level as indicated by a position of the magnet. The system further comprises a base station receiver transmitter unit for receiving a signal from the linear Hall Effect sensor transmitter unit and forwarding that signal to a remote registry, wherein the signal comprises data comprising at least the measured content level and a corresponding specific fluid holding tank identifier.

### BRIEF DESCRIPTION OF THE DRAWINGS

These and other features, aspects, and advantages of the present invention will become better understood with reference to the following description, appended claims, and accompanying drawings.

FIG. 1 shows a schematic of prior art.

FIG. 2 shows a close up of one portion of the prior art of FIG. 1.

FIG. 3 shows a schematic of one embodiment of the system of the present invention.

FIG. 4 shows a front view of one embodiment of a portion of the device of the present invention.

FIG. 5 shows a perspective view of embodiment of the device of the present invention.

FIG. 6 shows a rear cut away perspective view of embodiment of the device of the present invention.

FIG. 7 shows a side cut away perspective view of embodiment of the device of the present invention.

FIG. 8 shows a top cut away perspective view of embodiment of the device of the present invention.

FIG. 9a shows a Hall Effect sensor according to prior art.

FIG. 9b shows a Hall Effect sensor according to prior art.

FIG. 9c shows a Hall Effect sensor according to prior art.

FIG. 10 shows one embodiment of a method according to the present invention.

FIG. 11 shows a circuitry schematic for one embodiment of a remote receiving portion of the system of the present invention.

FIG. 12 shows one embodiment of a block diagram for the remote receiving portion of FIG. 1.

FIG. 13A shows a front view of another embodiment of a portion of the device of the present invention.

FIG. 13B shows a front view of another embodiment of a portion of the device of the present invention.

FIG. 14 shows a circuitry schematic for one embodiment of a base transmitter portion of the system of the present invention.

FIG. 15 shows one embodiment of a block diagram for the base transmitter of FIG. 13.

FIG. 16 shows one embodiment of a schematic of the method of the present invention.

### DETAILED DESCRIPTION

The present invention includes a sensor system for monitoring content level in a fluid holding tank and a cost effective method for requesting tank refills. The system is compatible with existing tank components and requires no retrofitting. Additionally, because of a lack of moving parts and an immunity to particulates like dust, dirt, mud and water, the sensor system of the present invention has a much longer life expectancy than other sensors, for example, optical and electromechanical sensors. Various features and advantages of the present invention are described below with reference to several preferred embodiments and variations thereof. Those skilled in the art, however, will understand that alternative embodiments of the structures and methods illustrated herein may be employed without departing from the scope and principles of the described invention.

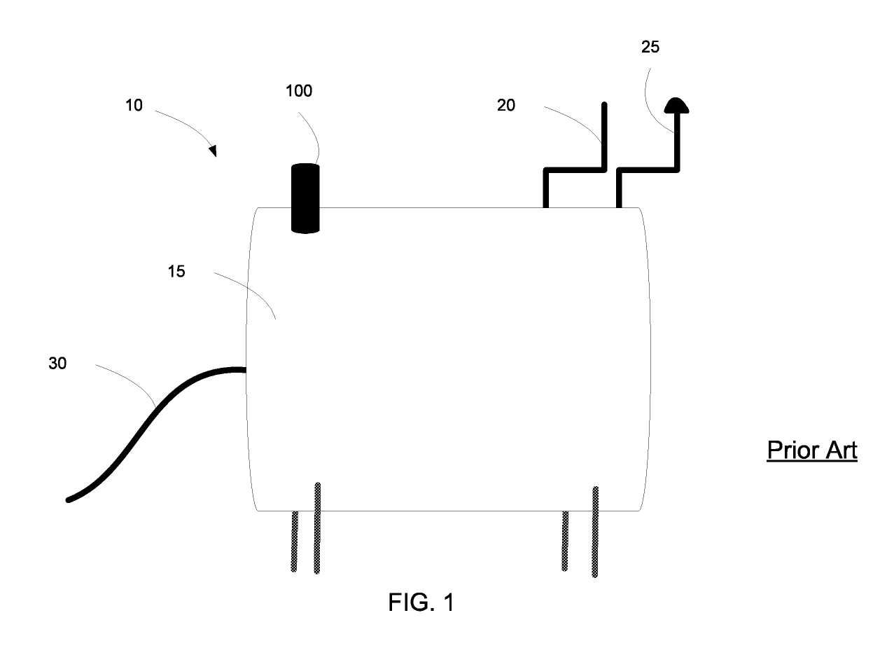

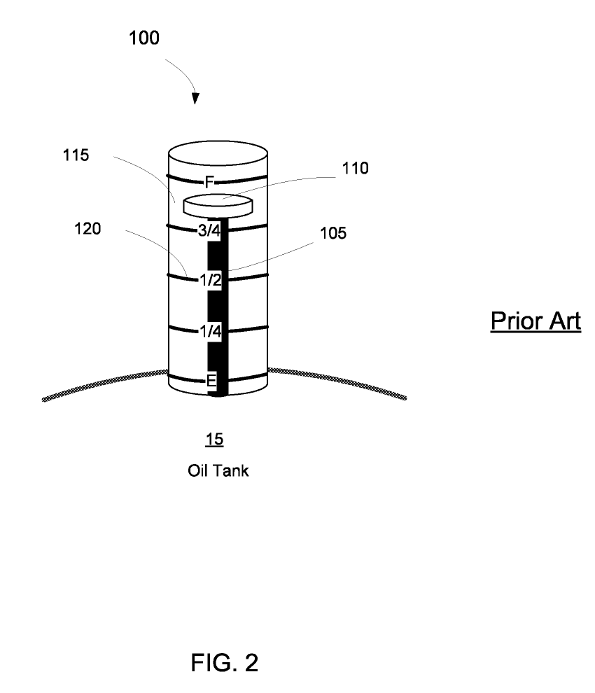

Turning now to FIGS. 1 and 2, a typical fluid holding tank system 10 and a typical indicator gauge 100 are shown. FIG. 1 particularly shows a home heating oil tank 15 having a fill line 20, an over flow pipe 25, and an oil line 30. The indicator gauge 100 is a commonly employed mechanical float gauge comprising a rod 105 terminating at one end in a float arm (not shown) disposed within the tank 15 and floating atop the fluid in the tank 15. The other end of the rod 105 terminates in a cap 110 that protrudes above the tank 15 and within a housing 115 having level markings 120 thereon for indicating an amount of fluid contained with the tank 15. This simple gauge 100 requires frequent manual monitoring to determine fluid content levels. A supply company unable to frequently monitor such a gauge 100 generally will rely on degree day calculations instead to determine frequency and volume of tank refills.

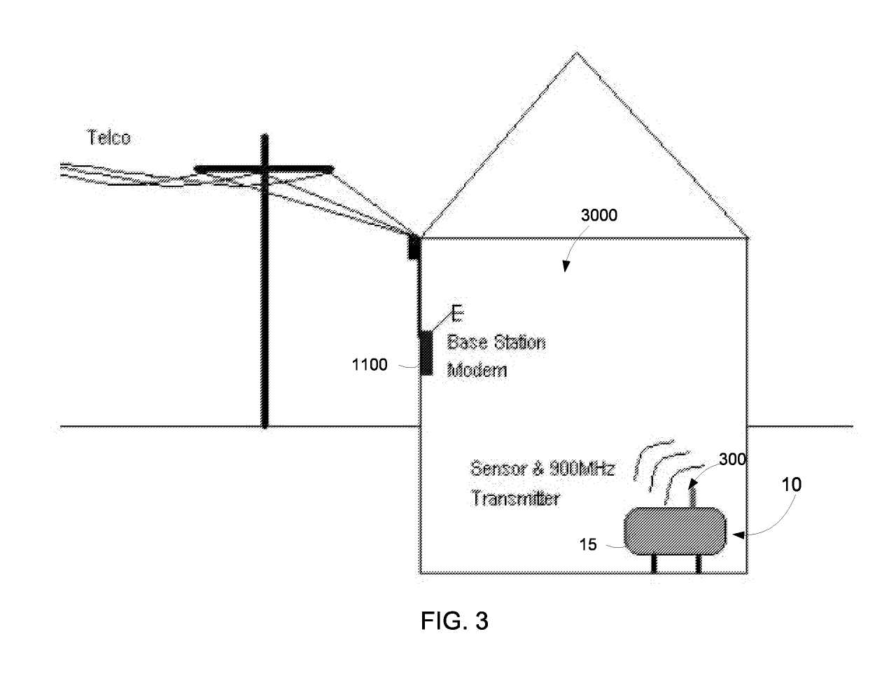

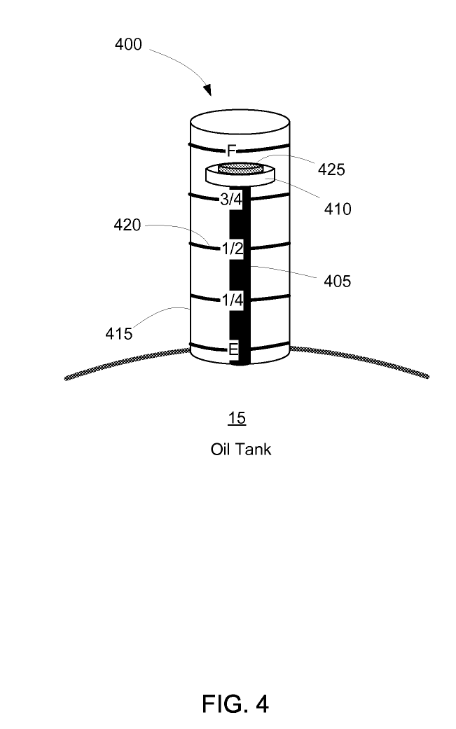

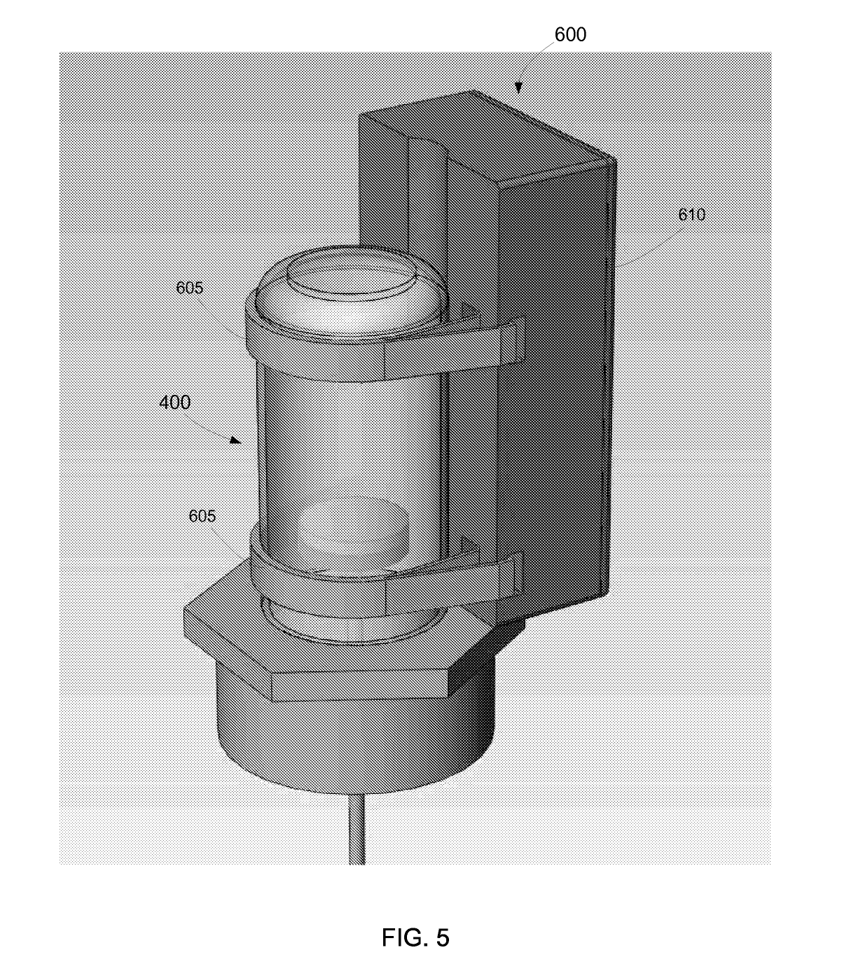

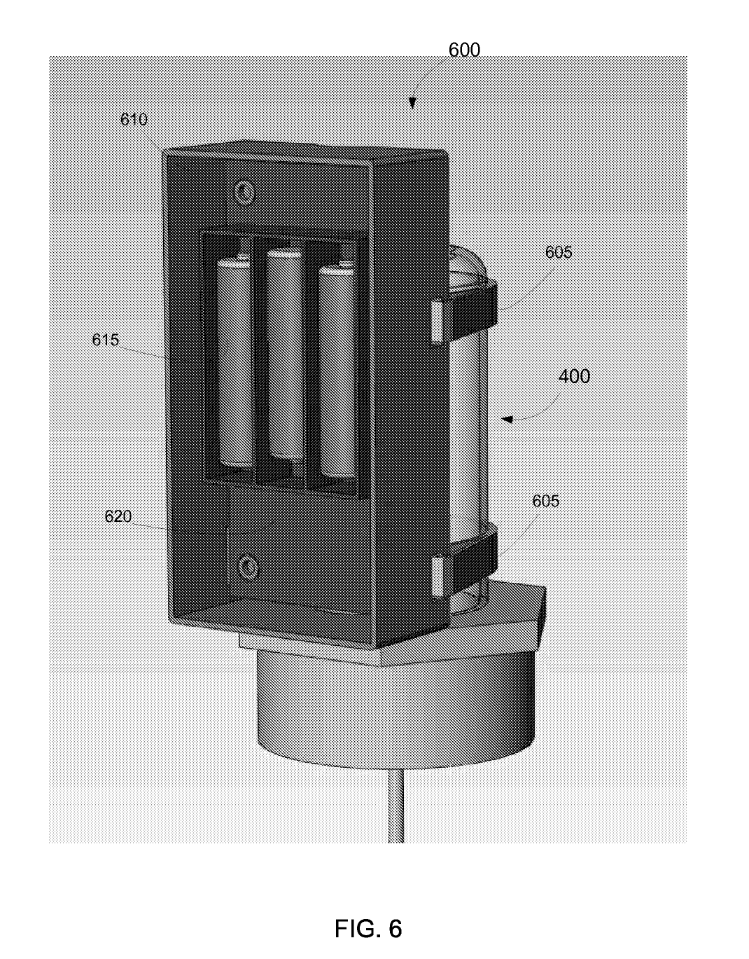

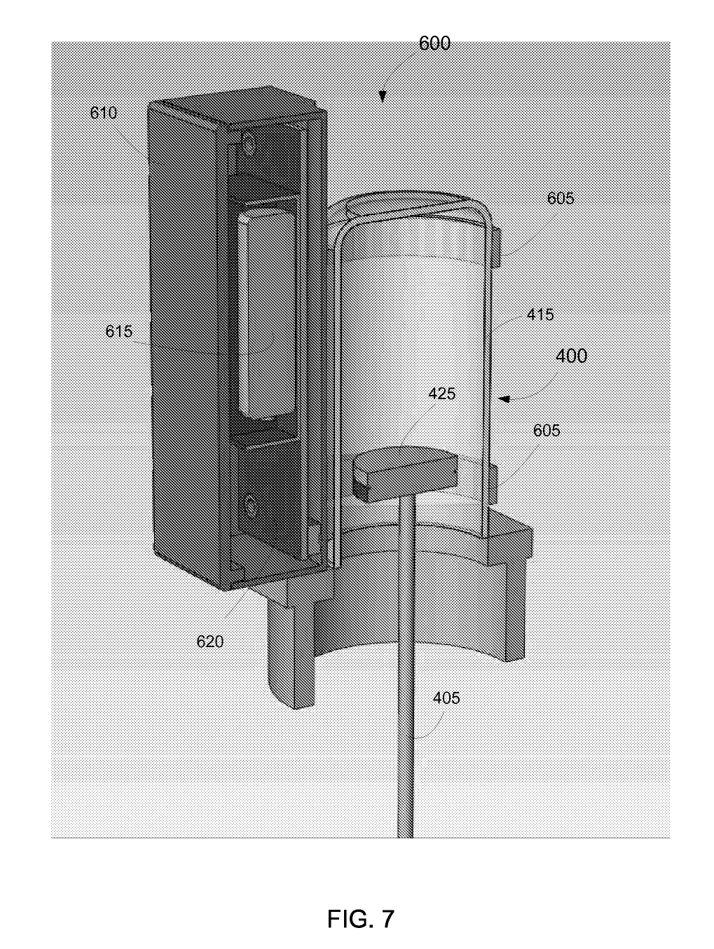

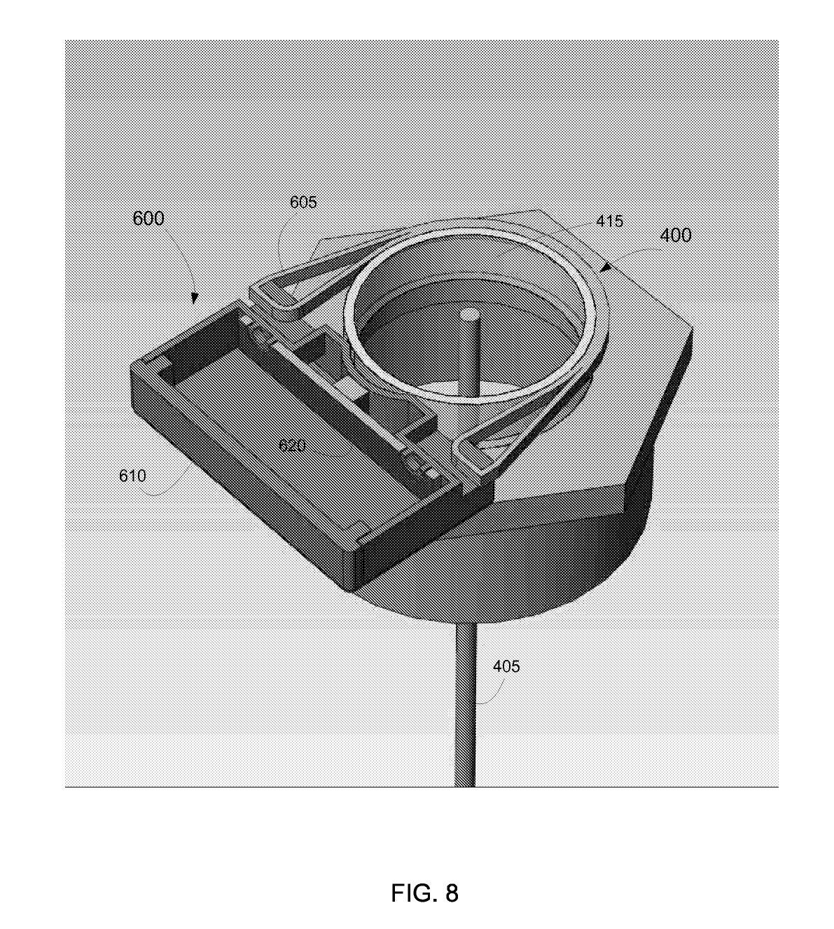

The present invention supplements the typical indicator gauge 100 with a device and system for accurately and automatically monitoring fluid levels and relaying that information to suppliers. FIG. 3 shows an overview of the system 3000 of the present invention. The system 3000 comprises a typical tank 15 having thereon the remote device 300 of the present invention which comprises a modified indicator gauge 400 shown in FIG. 4, a battery 615 shown in FIGS. 5 through 8, a Hall Effect sensor (not shown), microprocessor (not shown) and transmitter, described by way of example in FIG. 3 as a 900 MHz radio frequency (RF) transmitter. The remote device 300 may comprise hard wiring to a power outlet for receiving primary or back up power, but in a preferred embodiment, the remote device 300 is wireless.

Furthermore, any wired or wireless transmitter with appropriate range will suffice, but in a preferred embodiment, the device 300 incorporates a wireless transmitter for communicating with a base station 1400, here shown as incorporating a modem and RF receiver. The system 3000 of the present invention may employ any type of base station 1000 for receiving data from the device 300 and pushing that data to a third party through a wired or wireless means. Wired means may include but are not limited to a modem communicating via Plain Old Telephone Service (POTS) and a hardwired Internet connection, and wireless means may include an RF transmitter for signaling passing refill vehicles and wireless Internet communication with one or more remote servers. The following description provides further details of these elements of the device, system and method of the present invention.

Turning now to FIG. 4, one embodiment of a remote device 300 according to the present invention includes a modified indicator gauge 400 having a rod 405 therein terminating in a float arm (not shown) on one end and a cap 410 on the other end. The cap 410 moves vertically within a housing 415 having level markings 420 thereon. The indicator gauge 400 of the embodiment of the present invention, as depicted in the embodiment of FIG. 4, also comprises a metal element 425, such as a disc or a bob, affixed to the cap 410 by any known means, such as but not limited to adhesive, screws, and rivets. Preferably a non-conductive adhesive affixes the metal element 425 to the cap 410. Metal element 425 is formed from a material resistant to corrosives, such as but not limited to zinc, nickel, iron, copper, chromium and any alloy and/or combination of zinc, nickel, iron, copper and chromium. Any fluctuation in content level in the fluid holding tank 15 raises or lowers the float arm end of the rod 405 accordingly, thereby raising and lowering the metal element 410 within the housing 415.

The fluctuating metal element 410 triggers accurate measurements by a remote unit 600, shown in FIGS. 5 though 8. Remote unit 600 attaches to the indicator gauge 400 via an attachment means such as but not limited to rings, clamps, or ties. In the embodiment shown in FIGS. 5 though 8, the attachment means comprises one or more metal bands 605 encircling the indicator gauge and attaching to a sensor enclosure 610. The contents of the sensor enclosure 610 may comprise one or more batteries 615, a microprocessor (not shown) such as an integrated circuit, a Hall Effect sensor (not shown), and a transmitter (not shown) all in communication with a printed circuit board (PCB) 620.

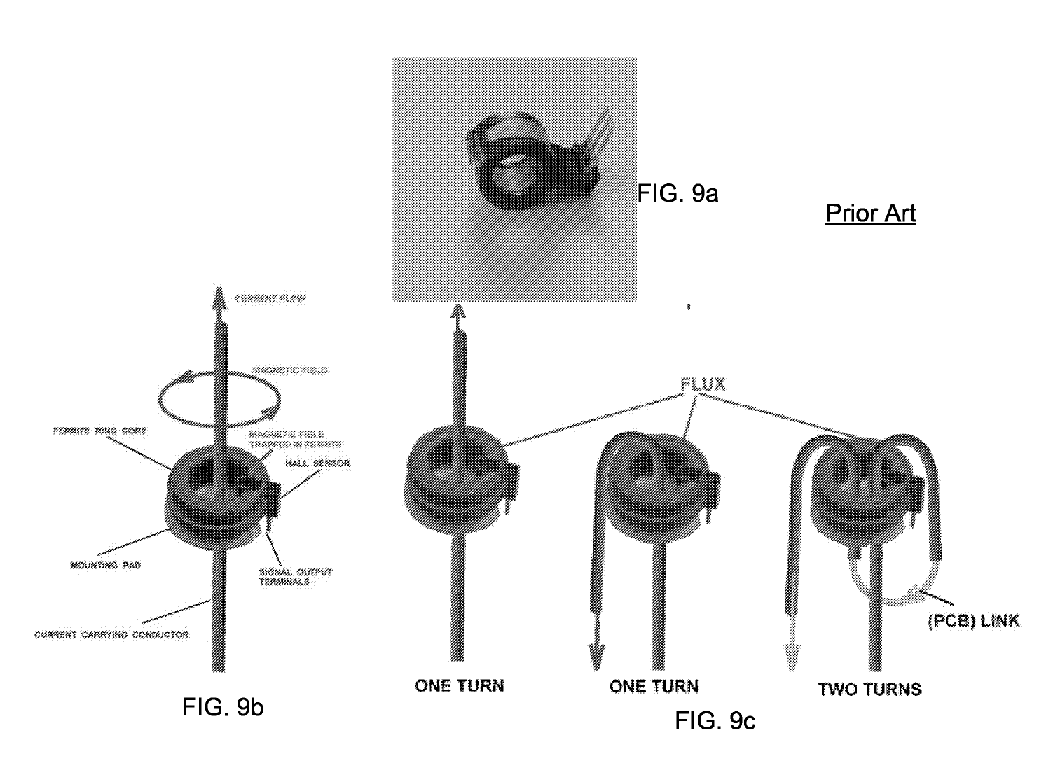

The Hall Effect sensor in the sensor enclosure 610 interacts with the metal element 425 to determine a fluid level in the holding tank. Hall Effect sensors are electromagnetic devices well known in the art. FIGS. 9a through 9c depict typical configurations of Hall Effect sensors, which include one or more current detecting loops for detecting any distortion in a magnetic field created by an electron flow. As shown most clearly in FIG. 9c, a Hall Effect sensor may provide more than one current detecting loop for more accurate sensing across a covered distance.

In the embodiment shown in FIGS. 5 through 8, the Hall Effect sensor of the present invention comprises at least one loop and more preferably comprises more than one loop for accurately determining the location of the metal element 425 within the vertical span covered by the current detecting loops. The one or more metal bands 605 of the present invention act as the current detecting loops of Hall Effect sensors, and the one or more batteries 615 provide the electron flow. As the rod 405 moves through the modified indicator gauge 400, the metal element 425 disrupts the magnetic field of the electron flowing through the metal bands 605. The Hall Effect sensor senses the degree of distortion caused by the metal element, which corresponds to a particular fluid level. The microprocessor then calculates a fluid level based on the determined location of the metal element 425 within the housing 415.

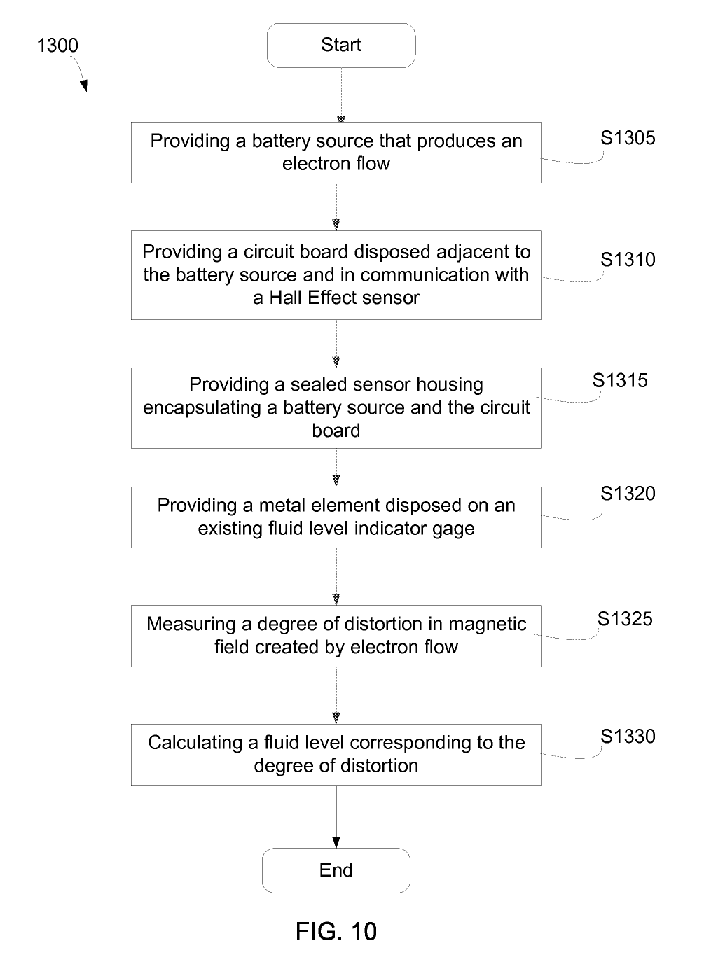

FIG. 10 is a diagram depicting a sensing method 1300 describing the operation of this remote unit 600. A first step S1305 comprises providing at least one battery 615 that produces an electron flow around the housing 415. Next, step S1310 comprises providing a circuit board 620 disposed adjacent to the at least one battery 615 and providing thereon a Hall Effect sensor having at least one current detecting loop, here the one or more metal bands 605, for detecting any distortion in the magnetic field created by the electron flow. A third step S1315 comprises providing a sealed sensor housing 610 encapsulating and protecting the at least one battery 615 and circuit board 620. The printed circuit board 620 and components thereon preferably comprise a conformal coating for protecting against contaminants commonly associated with the fluid holding tank 15.

A fourth step S1320 comprises providing a metal element 425 disposed on the cap 410 of the now modified fluid level indicator gauge 400. The metal element 425 is affixed to the cap 410 by an attachment means, such as a non-conductive adhesive. Any fluctuation in the fluid level in the tank 15 raises or lowers the rod 405 and the cap 410 of the modified indicator gauge 400 and affixed metal element 425. The metal element 425 creates a degree of distortion in the magnetic field of the electron flow associated with a particular position within the modified indicator gauge 400. A fifth step S1325 therefore comprises measuring a degree of distortion in the magnetic field of the electron flow and calculating a fluid level corresponding to that degree of distortion.

In one embodiment, the microprocessor of the base unit 600 may calculates the fluid level at prescribed intervals, for example, once a day. In yet another embodiment, the remote device 300 may continuously monitor fluid level and transmit data in response to a preset threshold fluctuation in fluid level. In either case, the remote unit 600 generally operates in a power conserving sleep mode, consuming greater quantities of power only when needed for calculating and transmitting fluid level data and other optional data, such as ambient temperature, and power level of the one or more batteries 615. In a preferred embodiment, the remote device 300 will return to a low power mode following transmission of the data packet.

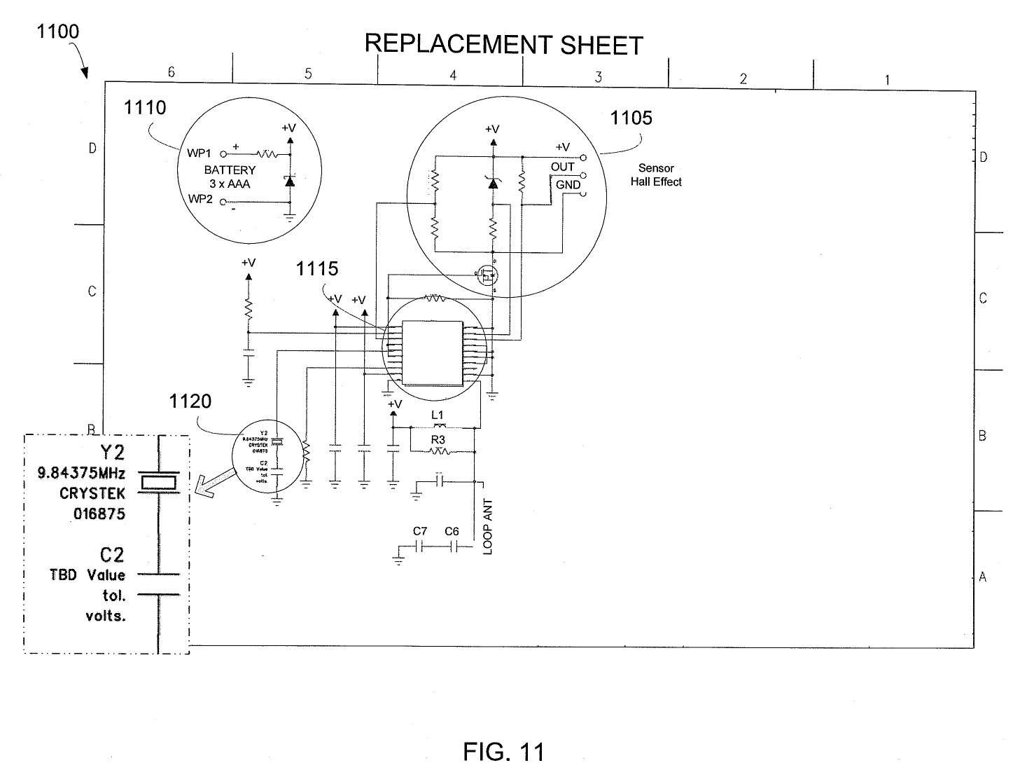

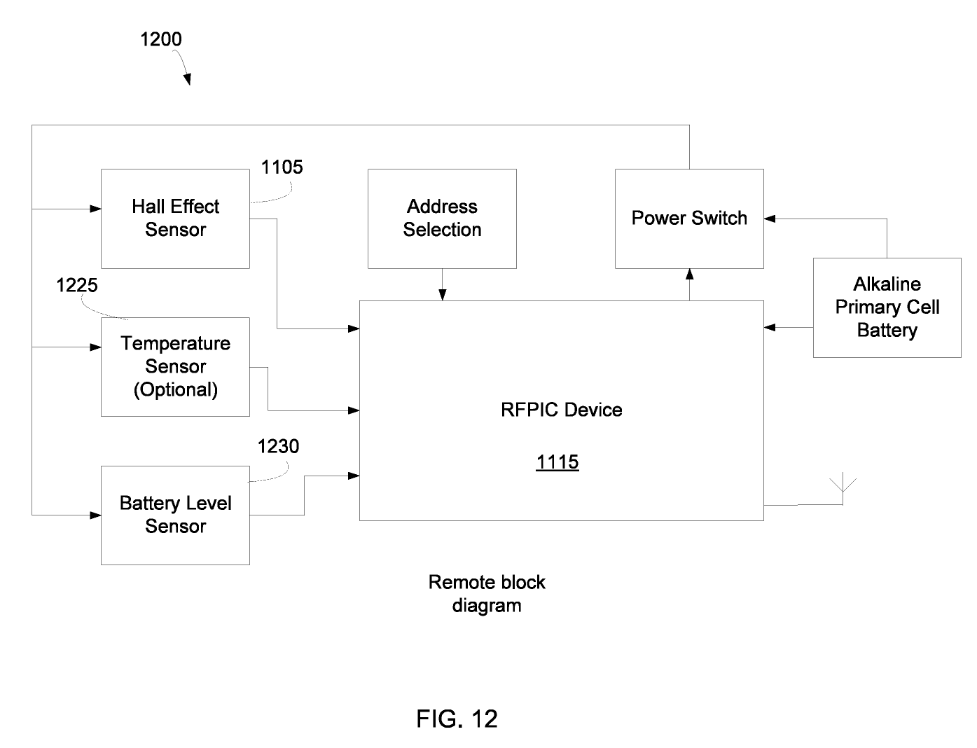

FIGS. 11 and 12 show one embodiment of a schematic 1100 and diagram 1200 of an embodiment of the remote unit 600 of the remote device 300. This embodiment of the remote device comprises the Hall Effect sensor wiring 1105, battery wiring 1110 for the one or more batteries 615, a microprocessor 1115 with a built-in RF transmitter, and at least one crystal oscillator 1120 for providing a clock signal. In one embodiment of the present invention, the RF transmitter operates in unlicensed frequency bands such as, for example, 315 MHz or 900 MHz in the United States or approximately 400 MHz in Canada. The RF transmitter therefore transmits through at least 100 feet indoors and through typical domestic construction materials, such materials between first and second flooring levels. As shown in the block diagram 1200 of FIG. 12, the remote device 300 also may incorporate a temperature sensor 1225 and a battery level sensor 1230 indicating power level of the one or more batteries 615 so that when the tank battery 615 reaches a predefined replacement threshold, the remote unit 600 transmits that condition as part of the data packet. The temperature sensor 1225 may provide a valuable indication of a “burner out” situation in which the fuel tank 15, overall heating system and/or boiler malfunctions, leaving a building unheated.

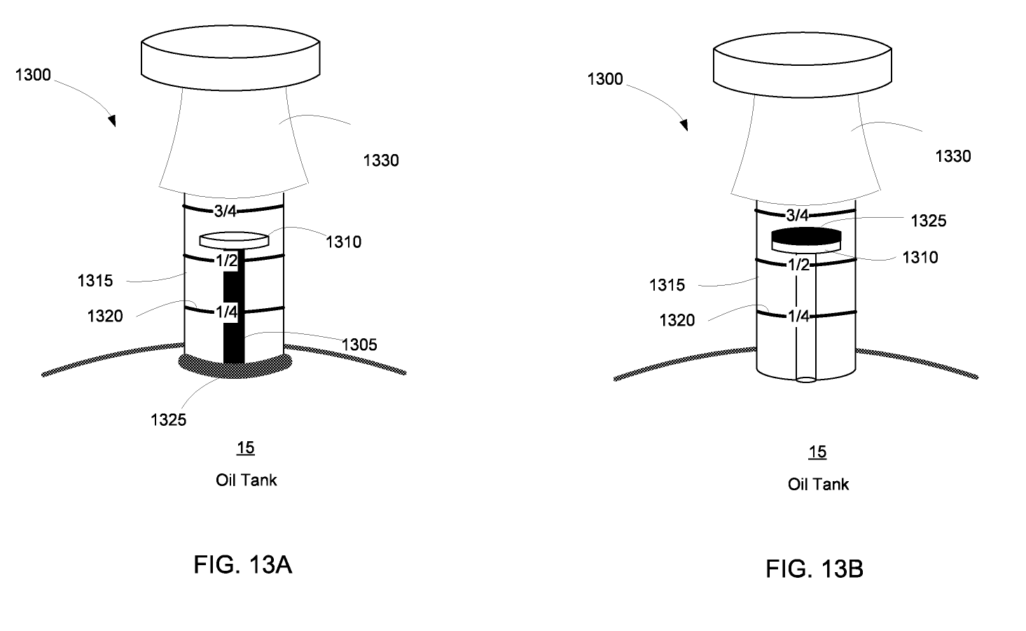

FIG. 13A shows an alternate embodiment of the remote device 300 of the present invention, here labeled 1300. In this alternate embodiment, the remote device 1300 comprises a magnet 1325 and a Hall Effect sensor-transmitter unit 1330 formed to rest securely atop an existing indicator gauge housing 1315. In one embodiment, the remote device 1300 has a substantially conical shape such that the remote device 1300 is wide enough at its widest aperture to receive the most substantial indicator gauge housings 1315. In one configuration, the magnet 1325 may encircle the base of the existing indicator gauge housing 1315 on a fluid tank 15 and couple to a rod 1305 made from a conductive metal, such as iron. In another embodiment, the rod 1305 may be, for example, a 3/32 inch diameter 1018 steel rod with an iron cap 1310. As the rod 1305 raises and lowers along with a fluctuating fluid level in the tank 15, the magnetic field between the magnet 1325 and rod 1305 also fluctuates. The Hall Effect sensor transmitter unit 1330 comprises a Hall Effect sensor (not shown) for detecting fluctuations in the magnetic field and a transmitter means, such as an RF transmitter, for transmitting fluid level data. Some known Hall Effect sensor transmitter integrated circuit assemblies that may fit within the substantially conical remote device 1300 are those made by Allegro®, Melexis®, Nippon Telecom, and Siemens, for example. Additionally, the Hall Effect sensor-transmitter unit 1330 may further comprise a battery (not shown), temperature sensor (not shown) and battery level sensor (not shown).

FIG. 13B depicts a similar alternate embodiment of the remote device 1300. In this alternate embodiment, the remote device 1300 comprises a disc-shaped magnet 1325 disposed on the indicator gauge cap 1310 and a linear Hall Effect sensor-transmitter unit 1330 formed to rest securely atop an existing indicator gauge housing 1315. The embodiment of FIG. 13B comprises a specific magnetic field that enables increased precision in sensor measurements as compared to the sensor measurements of the induced magnetic field of the embodiment of FIG. 13A. The magnet 1325 may be affixed to the cap 1310 by any known means, such as but not limited to adhesive, screws, and rivets. Preferably a non-conductive adhesive affixes the magnet 1325 to the cap 1310. The magnet may be a permanent magnet fabricated from a rare earth metal or a rare earth metal alloy, such as a neodymium alloy (Nd₂Fe₁₄B), which comprises neodymium, iron and boron. Preferably the Hall Effect sensor is a linear Hall Effect sensor such as, for example, the Allegro® A132X series of ratiometric linear Hall Effect sensors. Any linear Hall Effect sensor providing low power consumption, high resolution output and easy calibration characteristics would be suitable for application in a remote device 1300 according to the embodiment of FIG. 13B. Using such a linear sensor enables a precise sensor reading related directly to the strength of the field emanating from the magnet 1325 atop the cap 1310. The voltage output of the linear Hall Effect sensor is proportional to the applied magnetic field. This enables simplified calculations for determining content levels and signaling refill conditions.

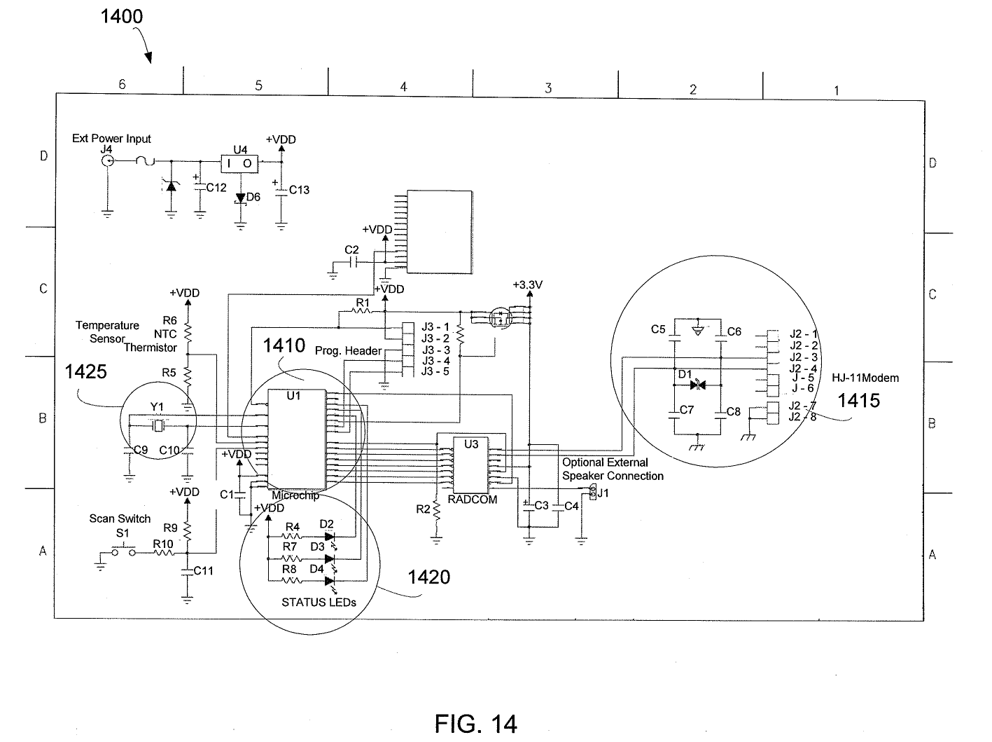

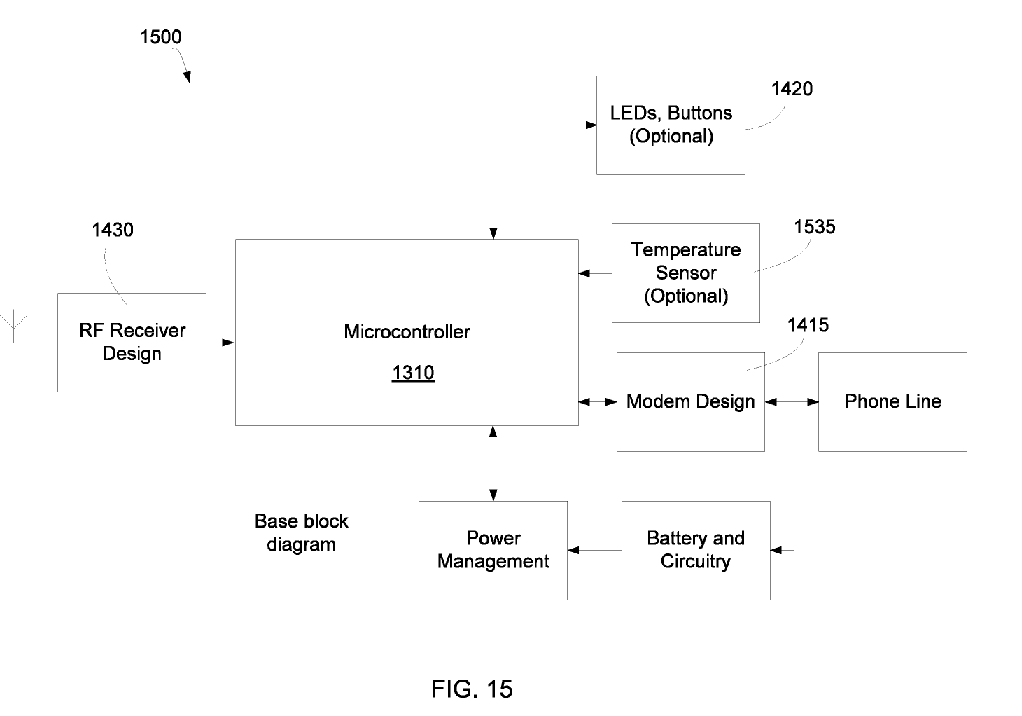

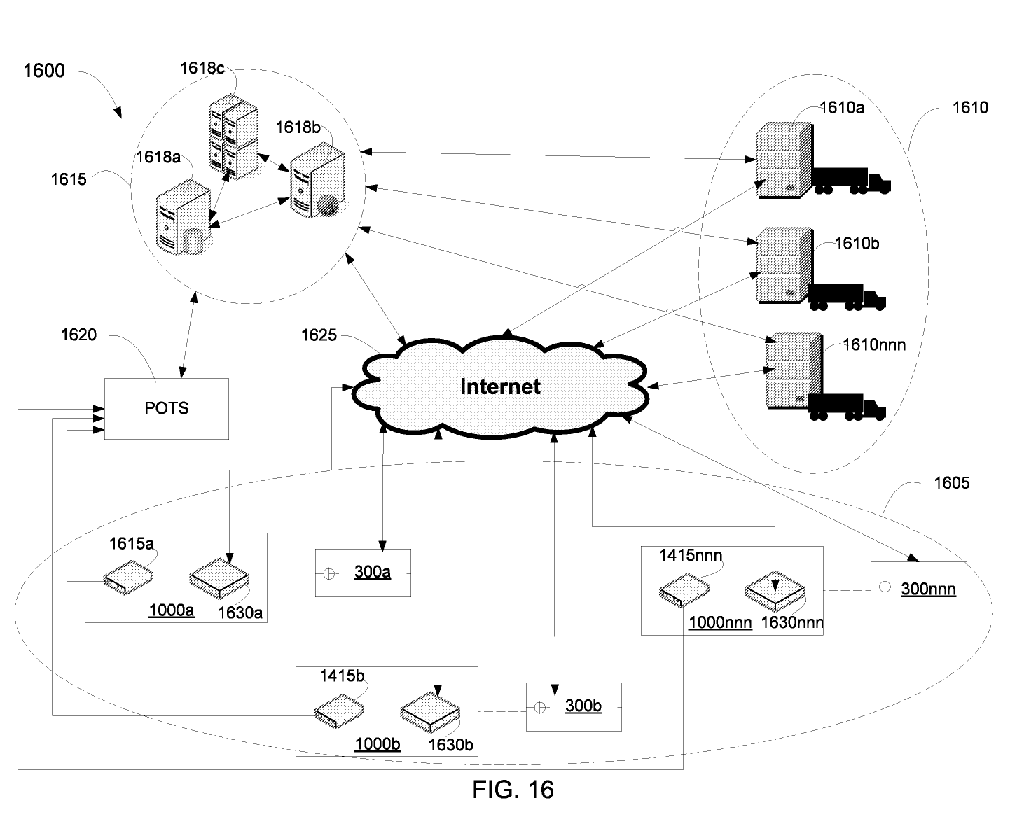

Returning now to the embodiment of the present invention shown in FIGS. 4 though 8, once the remote device 300 senses a fluid level and optionally senses battery level and ambient temperature, the RF transmitter pushes a data packet of information to the base station 1000. FIGS. 14 and 15 show an embodiment of a schematic 1400 and diagram 1500 of one embodiment of the base station 1000 of the present invention, and FIG. 16 provides a diagram of the notification method 1600 for disseminating information from a plurality of users 1605 of the remote device 300 and base station 1000 of the present invention to a plurality of fuel suppliers 1610.

In the embodiment of FIGS. 14 and 15, the base station 1000 comprises a modem 1415 and receiver 1530 that wirelessly receives an RF transmission from the remote device 300. In one embodiment, the RF receiver operates in unlicensed frequency bands, for example, 315 MHz or 900 MHz in the United States or approximately 400 MHz in Canada. Base station 1000 also optionally comprises an ambient temperature sensor. Additionally, the base station may comprise one or more status LEDs 1420 for troubleshooting purposes. In one embodiment, the remote device 300 and base station 1000 both further comprise a connection means, such as pushbuttons, to link and lock with one another during an initial configuration. The remote device 300 and base station 100 also may comprise reset buttons that erase all linked numbers. In such an embodiment, base stations 1000 may be generic devices, and each remote device 300 may comprise a unique, hard coded address that uniquely identifies a particular tank 15.

In one embodiment, the base station 1000 further comprises an AC adapter for supplying power. Alternatively, in another embodiment, the modem 1415 may run on telephone line power and may further comprise a chemical storage battery for high-power operating intervals, such as data transmission intervals. In the later embodiment, the storage battery may be rechargeable and may recharge via power drawn from the telephone line.

In one embodiment, the base station 1000 is capable of resting on a countertop or, alternatively, mounting to a wall for easy access and display. Some displayed information may include an online transmission signal or a signal representing an attempt to redial in the case of a base station 1000 comprising a modem 1415. The base station also may comprise indicators for replacing the at least one sensor battery 615 and/or detecting an error.

Returning now to the method of supplying data to plurality of fuel suppliers 1610, in one embodiment of the present invention, the base station 1000 operates in a lower power mode while listening for a periodic broadcast from the remote device 300. The periodic broadcasts contain a data packet generally containing bits of information related to fluid level in the tank 15, battery status for the at least one battery 615, and an ambient temperature reading. The base station 1000 may measure ambient temperature directly in one embodiment. Once the base station 1000 receives data, the base station 1000 then pushes those bits of data to a remote registry 1615 via a modem 1415 connected through a telephone line to POTS 1620, or via a wired or wireless connection to the Internet 1625. In an embodiment wherein the base station 1000 comprises a modem 1415, the base station 1000 preferably connects in serial with an existing phone line so that phone service is uninterrupted. A dialed phone number for the remote registry 1615 may be a toll free number. In an alternative embodiment wherein the base station 1000 communicates via a wired or wireless connection to the Internet 1625, the base station 1000 may comprise a network adapter 1630 and an intermediary router (not shown) may exist between the base station 1000 and Internet 1625. In yet another embodiment, the remote device 300 also may incorporate a communication means, such as a network adapter, for connecting with the Internet 1625 directly via wired or wireless means to transmit data.

Turning now to the remote registry 1615, one or more servers 1618 may communicate with the plurality of users 1605 and plurality of service providers 1610. In a preferred embodiment, the remote registry 1615 is in communication with the Internet 1625 via wired or wireless connection means, including but not limited to one or more wired or wireless routers (not shown). The one or more servers 1618 may include a data server 1618a for storing a database of information related to the plurality of users 1605, a web server 1618b for providing account access to the plurality of users 1605 and/or the plurality of suppliers 1610 via the Internet 1625, and/or an application server 1618c for storing and executing code that parses incoming data and integrates data with existing software at the plurality of suppliers 1610.

The remote registry 1615 receives, parses and stores a transmitted data packet related to specific customer accounts for the plurality of users 1605. A unique service account number may be, for example, a serial number of the remote device 300, a telephone number, or a MAC address for embodiments of the present invention wherein the base station 1000 and/or remote device 300 include a network adapter. The remote registry 1615 thus stores fluid level, temperature information, and status information related to a particular remote device 300 for a particular customer account. The remote registry 1615 then pushes that data to one or more of the plurality of fuel suppliers 1610 per parameters stored in the database. The remote registry 1615 may store preference information related to each customer account which may include a preferred communication frequency and means as specified by one or more of the plurality of suppliers 1610. Such communication means may include for example, emails, interactive web account postings, faxes, and/or automated calls. Additionally, the remote registry 1615 may monitor the data transmissions for any service related data and send alerts to heating system servicers and/or the plurality of fuel suppliers 1610 that a particular system 3000 requires service.

The remote registry in addition to receiving and pushing information may monitor data continuously for customer accounts and alert the plurality of suppliers 1610 of any aberrant condition, such as low fuel or low ambient temperature, for example. One of the plurality of suppliers 1610 may receive notification, for example, if a fluid level in a particular tank 15 fails to fluctuate according to pervious patterns. A lack of fluctuation or a relatively small fluctuation may indicate malfunctioning equipment as might too large a fluctuation.

The remote registry 1615 may provide the plurality of suppliers 1610 with other valuable data. For example, in one embodiment of the present invention, the remote registry will notify the plurality of suppliers if ambient temperature drops below 45 degrees or if fluid level in a tank 15 drops below a threshold volume for refill. The remote registry 1615 also may run software thereon (not shown) for optimizing deliveries by the plurality fuel suppliers 1610 to the plurality of users 1605. This software system may enable the plurality of fuel suppliers 1610 to route delivery trucks well in advance of deliveries. The executable software optimizes truck routes by densely concentrating deliveries and maximizing the amount of fuel delivered to each of the plurality of users 1605 during each refill. By minimizing the miles driven by delivery trucks and maximizing both the number of deliveries and quantity of fuel delivered each day, the software produces cost savings to the plurality of suppliers 1610. This subsequently may result in a cost savings to the plurality of users 1605. The remote registry 1615 and executable software running thereon may provide optimized routing and delivery data directly to the plurality of fuel suppliers 1610 and/or the executable software may integrate with existing software applications run by the plurality of suppliers 1610 to maximize and optimize deliveries.

Additionally, the remote registry 1615 may allow the plurality of users 1605 to register a remote device 300 through an online registration form hosted by the remote registry 1615 and made accessible via the internet 1625. The plurality of users 1605 then may monitor their measured fuel levels by accessing data tracked and stored by the remote registry 1615. Alternatively, the remote registry 1615 may push reorder alerts out to registered users 1605 via known communications means such as text messaging, email, and fax. The remote registry 1615 and software application thereon further may enable the plurality of users 1605 to order fuel at the lowest cash price of the day, maximizing cost savings.

The present invention therefore prevents dire consequences, such as pipe freezing because of malfunctioning boilers or oil burners. In alternate embodiments, the present invention may incorporate a remote boiler lockout alarm. Additionally, the device, system and method of the present invention may prevent tanks 15 from running empty while simultaneously optimizing fluid deliveries such that the plurality of suppliers 1610 may refill tanks when they are most empty. The device, system and method of the present invention, therefore, may enable sophisticated truck routing, scheduling and delivery management via software means, as well as integrating with Internet-enabled accounting and operating software for the plurality of suppliers 1610 having online ordering systems.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A minimally intrusive system for determining content level in a fluid holding tank, the system comprising:
a. a magnet disposed around the base of a housing for an existing content level gauge, wherein the magnet produces a magnetic flux around the housing;
b. a Hall Effect sensor transmitter unit disposed on the housing and having at least one current detecting loop therein for detecting any variation in a magnetic field created by the magnet and a metal content level gauge disposed within the housing, wherein the degree of variation corresponds to a measured content level as indicated by a position of the metal content level gauge; and
c. a base station receiver transmitter unit for receiving a signal from the Hall Effect sensor transmitter unit and forwarding that signal to a remote registry, wherein the signal comprises data comprising at least the measured content level and a corresponding specific fluid holding tank identifier.

2. The system of claim 1 wherein the Hall Effect sensor transmitter unit communicates with the base station via wired means.

3. The system of claim 1 wherein the Hall Effect sensor transmitter unit communicates with the base station via wireless means.

4. The system of claim 1 wherein the Hall Effect sensor transmitter unit has a substantially conical shape for engaging the housing.

5. The system of claim 1 wherein the metal content level gauge comprises a metal rod.

6. The system of claim 5 wherein the metal rod is iron.

7. The system of claim 5 wherein the metal rod is steel.

8. The system of claim 7 wherein the metal rod comprises an iron cap.

9. A system for determining content level in a fluid holding tank, the system comprising:
a. a linear Hall Effect sensor transmitter unit disposed on a housing for an existing content level gauge for detecting any variation in a magnetic field created by a magnet disposed on the content level gauge disposed within the housing, wherein the degree of variation corresponds to a measured content level as indicated by a position of the magnet; and
b. a base station receiver transmitter unit for receiving a signal from the linear Hall Effect sensor transmitter unit and forwarding that signal to a remote registry, wherein the signal comprises data comprising at least the measured content level and a corresponding specific fluid holding tank identifier.

10. The system of claim 9 wherein the linear Hall Effect sensor transmitter unit communicates with the base station via wired means.

11. The system of claim 9 wherein the linear Hall Effect sensor transmitter unit communicates with the base station via wireless means.

12. The system of claim 9 wherein the linear Hall Effect sensor transmitter unit has a substantially conical shape for engaging the housing.

13. The system of claim 9 wherein the magnet is a rare earth metal permanent magnet.

14. The system of claim 13 wherein the magnet is made of an alloy containing iron.

15. The system of claim 13 wherein the magnet is made of neodymium.

16. The system of claim 9 wherein the linear Hall Effect sensor is a ratiometric sensor that provides a voltage output that is proportional to an applied magnetic field of the magnet.
